(19) United States
(12) Patent Application Publication
(10) Pub. No.: US 2017/0218274 A1
(43) Pub. Date: Aug. 3, 2017

(54) Waste Incinerator

(71) Applicants: Shizheng YU, Beijing (CN); Xiuying YU, Changzhou (CN)

(72) Inventors: Shizheng YU, Beijing (CN); Xiuying YU, Changzhou (CN)

(21) Appl. No.: 15/430,566

(22) Filed: Feb. 13, 2017

Related U.S. Application Data
(63) Continuation-in-part of application No. PCT/CN2015/085006, filed on Jul. 24, 2015.

(30) Foreign Application Priority Data
Aug. 12, 2014 (CN) 201410393458.8

(51) Int. Cl. C10B 1/04; C10B 27/06; C10B 49/02; C10B 57/10; F23J 15/02; C10J 3/66; C10J 3/84; C10K 3/00; F23G 5/027; C10B 21/10; B09B 3/00

(52) U.S. Cl. CPC C10B 1/04; C10B 21/10; C10B 27/06; C10B 49/02; C10B 57/10; B09B 3/0083; C10J 3/66; C10J 3/84; C10K 3/00; F23G 5/0276; F23J 15/022; B01D 47/10

(57) ABSTRACT

A waste incinerator, in a vertical structure and including from the top down: a drying section, a destructive distillation section, a reduction section, and a combustion section. The combustion section includes: two layers of grate bars, a first combustion layer, a second combustion layer, and a third combustion layer. The heat produced from the combustion in the combustion section is used to heat the carbide in the reduction section. The heated carbide reduces CO₂ produced in the combustion into CO (coal gas). The coal gas ascends to the destructive distillation section through the ambient coal gas chamber to heat and destructively distillate the waste to produce the pyrogenic coal gas and the carbide. The carbide drops to the combustion section for combustion, and the pyrogenic coal gas and the coal gas are collected by the draft fan.

### CROSS-REFERENCE TO RELATED APPLICATIONS

This application is a continuation-in-part of International Patent Application No. PCT/CN2015/085006 with an international filing date of Jul. 24, 2015, designating the United States, now pending, and further claims foreign priority benefits to Chinese Patent Application No. 201410393458.8 filed Aug. 12, 2014. The contents of all of the aforementioned applications, including any intervening amendments thereto, are incorporated herein by reference. Inquiries from the public to applicants or assignees concerning this document or the related applications should be directed to: Matthias Scholl P.C., Attn.: Dr. Matthias Scholl Esq., 245 First Street, 18th Floor, Cambridge, Mass. 02142.

### BACKGROUND OF THE INVENTION

The invention relates to a waste incinerator.

The following problems pertain to conventional waste incineration:

1. Production is dioxins as byproducts.

2. Production of a large amount of fly ash to which dioxin adheres, causing environmental pollution.

3. Production of a large amount of harmful gases. Waste is required to be stored in the incinerator for between 7 and 30 days, which leads to stench, leachate pollution, and increased treatment cost.

4. Design defects. Because, conventionally, no heat source is disposed beneath the drying section of the grate incinerator, the combustion of the waste which contains much water is nearly always incomplete. In addition, the air supply to the grate incinerator is uneven. This accelerates the production of dioxin. Although the fluidized bed waste incinerator, the high-temperature fusion incinerator, and even the pure oxygen or plasma incinerator have been developed, the apparatus still leaves much to be desired.

### SUMMARY OF THE INVENTION

In view of the above-described problems, it is one objective of the invention to provide a waste incinerator which adopts a vertical structure and comprises: a drying section, a destructive distillation section, a reduction section, a combustion section (comprising a first combustion layer, a second combustion layer, and a third combustion layer), and a ash section from the top down so as to form a reasonable heating structure where the waste is introduced from the top down and the heat quantity is transferred from the bottom up, a gas exhaust structure where waste heat of coal gas and pyrogenic coal gas are fully utilized, a highly effective combustion structure that automatically realizes fire poking and combustion in different layers, automatic closed-loop control of the combustion temperature, the best control, and the open type ash discharge structure.

The waste incineration process is as follows: the waste is fed into the waste incinerator via a top thereof by adopting an automatic loading control system. The waste is introduced from the top down and is first dried in the drying section, destructively distillated and decomposed into the pyrogenic coal gas and the carbide residue in the destructive distillation section. The carbide residue falls through the reduction section to the combustion section (including the first combustion layer, the second combustion layer, and the third combustion layer) where the carbide contacts with the air for combustion. The heat quantity produced from the combustion of the carbide in the combustion section is transferred from the bottom up to heat the non-combusted carbide on the first combustion layer to a high temperature, thus converting the heated non-combusted carbide into a reducing agent and forming the reduction section. Under the action of the high-temperature carbide, CO₂ is reduced into CO, i.e., the coal gas. The coal gas ascends via the ambient coal gas chamber to reach the destructive distillation section. The waste is dried and accumulated in the destructive distillation section and excluded from air. The waste, as being heated by the high temperature carbide in the reduction section and at the same time radioactively heated by the coal gas in the ambient coal gas chamber, is destructively distillated and decomposed to produce the pyrogenic coal gas which then enters the ambient coal gas chamber and ascends after being mixed with the coal gas in the coal gas chamber. The mixed coal gas passes through the drying section to dry the waste and is finally collected at the top of the waste incinerator for subsequent utilization. The water vapor produced from the drying of the waste ascends to form an upper section gas which functions as the gasification agent of the carbide and the dedusting agent of the mixed coal gas, to ensure that the destructive distillation of the waste is prior to the combustion of the carbide residue and that CO₂ produced from the combustion of the carbide residue is reduced into CO, thus realizing the zero production of the dioxin and zero discharge of the waste gas during the waste incineration.

In addition, the waste incinerator in the past often adopts the pressurized incineration mode by using air blasting, which produces a large quantity of fly ash. In order to inhibit the production of the fly ash, the draft fan is utilized to suck the pyrogenic coal gas and the coal gas, and to suck the air (or the oxygen-enriched air) and the water vapor acquired from the upper section gas as the gasification agent to the combustion section for accelerating the combustion of the waste. Because the negative-pressure combustion is adopted, the waste feeding port and the ash discharge port are both in a slight negative-pressure state, and pressures in and outside the incinerator are in balance. No additional sealing measurement is required, and the waste incinerator can be completely open to the external without leading to leakage.

The condition of the waste combustion inside the incinerator is controlled by a system for automatic closed-loop control of the combustion temperature. The incinerator is divided into between 4 and 8 zones in a horizontal cross section. In condition that the combustion temperature of a certain zone is not high enough, an auxiliary water/gas feeding channel is utilized to supplement the air (or the oxygen-enriched air) to such zone, so that the combustion of the carbide is enhanced and the combustion temperature is increased. When the combustion temperature of the waste in a certain zone is too high, the auxiliary water/gas feeding channel is utilized to supplement water vapor (from the upper section gas) to such zone. The water vapor is reduced into H₂ and CO (heat absorption reaction) by the high temperature carbide in the reduction section, so that the combustion temperature is reduced and the automatic closed-loop control of the combustion temperature inside the incinerator is realized. Thus, the new structure and new incineration process realizing the destructive distillation of the waste and the subsequent combustion of the carbide residue are formed. Besides, the open type waste feeding and ash discharging are realized due to the negative-pressure combustion. A large-scale waste incinerator can be designed by using combinations of units to satisfy requirements of different treatment capacity.

Technical solution solving the technical problem is as follows:

The horizontal arrangement of the structure including the drying section, the combustion section, the burnout section, and the ash discharge section in the prior art is converted into the vertical arrangement, which includes: the drying section, the destructive distillation section, the reduction section, the combustion section (including the first combustion layer, the second combustion layer, and the third combustion layer), and the ash discharging layer (which is also the third combustion layer). To make the subsequent unit combination much easier, a furnace adopts a rectangular cross section to form an incinerator structure including the standard cubic-shaped incinerator unit for destructive distillation and incineration of the waste. The waste is fed into the incinerator from the top thereof, dried in the drying section where the produced water vapor ascends to form the upper section gas while the dried waste drops to the destructive distillation section. The water vapor produced from the drying of the waste in the drying section excludes the air out of the gaps among the wastes so as to form an air exclusion condition. The high temperature heat quantity produced from the combustion of the carbide is upwardly supplied to heat the waste, while the coal gas also ascends and radioactively heats the waste via the inner wall of the coal gas chamber. The waste is therefore destructively distillated and decomposed, in the destructive distillation section, into the pyrogenic coal gas. The pyrogenic coal gas then enters the coal gas chamber to be mixed with the coal gas, and the resulting mixed gas is collected by using the draft fan for subsequent utilization. In order to enhance the combustion of the carbide, improve the air permeability, enlarge the combustion range, and increasing the combustion efficiency, the two layers of grate bars are arranged to separate the combustion section into the first combustion layer, the second combustion layer, and the third combustion layer (also functioning as the ash discharge section). By designing that intervals of an upper layer of the grate bars are wider than intervals of a lower layer of the grate bars, when the carbide on the upper layer of the grate bars is combusted, carbide having reduced volumes automatically drops onto the lower layer of the grate bars to continue combustion; as the volume of the carbide further reduces, the carbide fall to the third combustion layer, or the ash discharging section, to continue combustion until the carbide is completely combusted, thus realizing the automatic fire poking and complete combustion. The carbide in the reduction section is directly heated by the heat quantity produced from the combustion of the carbide. The high temperature carbide functions as a reducing agent and reduces CO₂ produced from the combustion and the water vapor into CO and CO+H₂, as the coal gas. The coal gas ascends via the coal gas chamber in the ambient of the waste. The temperature in the destructive distillation section is approximately between 600 and 900° C., which is sufficient to heat, destructively distillate, and decompose the waste of the destructive distillation section in the radiation mode. Slits are disposed on an inner wall of the coal gas chamber surrounding the waste of the destructive distillation section. With the progress of the destructive distillation of the waste, the pyrogenic coal gas enters the coal gas chamber as well to form the mixed coal gas. Although the temperature of the mixed coal gas in the drying section decreases to the temperature of between 200 and 600° C., the temperature of the mixed coal gas is still high enough to dry the waste via the radiation heating. Thus, a complete heating structure of the waste incinerator is formed. The water vapor produced from the waste drying passes through the gaps among the waste at corners of the cooling fins to reach a top of the waste incinerator where the water vapor is accumulated into an upper section gas. This kind of gas exhaust passage is specially designed for discharging the water vapor. The water vapor is used as a gasification agent for the carbide, after being merged with the mixed coal gas, it is also utilized as the dedusting agent of the mixed coal gas. The combustion state of the waste inside the incinerator is controlled by the system for automatic closed-loop control of the combustion temperature. The waste incinerator is divided into between 4 and 8 zones in the horizontal cross section. When the combustion temperature of a certain zone is not sufficient, the air or the oxygen-enriched air is complemented to the auxiliary water/gas feeding channel, so as to enhance the combustion of the carbide and to improve the combustion temperature. When the combustion temperature of the waste in a certain zone is too high, the water vapor (from the upper section gas) is fed to such zone via the auxiliary water/gas feeding channel. The water vapor is reduced by the high temperature carbide in the reduction section to produce H₂ and CO (heat absorption reaction). On one hand, the combustion temperature is reduced and the normal combustion is kept; on the other hand, the caloric value of the mixed coal gas is improved, realizing the innovative automatic closed-loop control and the best control of the combustion temperature inside the incinerator.

In order to decrease the ash in the coal gas, the positive-pressure combustion adopting the air blasting mode in the conventional waste incinerator is converted into the negative-pressure combustion adopting air extraction. At the same time the mixed coal gas is extracted by the draft fan, the air (or the oxygen-enriched air) and the water vapor, functioning as the gasification agent, are extracted to the combustion section and enables the carbide completely combusted, and resulting ashes are then discharged. Because the negative-pressure combustion in the form of air extraction is adopted, both the waste feeding port and the ash discharge port are in a slight negative-pressure state, pressures in and outside the incinerators basically keep in balance. No sealing measurement is required, and the waste incinerator can be completely open to the external without leading to leakage.

Advantages of the waste incinerator in accordance with embodiments of the invention are summarized as follows:

1. The dioxin is neither produced in the decomposition of the waste since the destructive distillation of the waste excluded from the air does not lead to the occurrence of the oxidation, nor in the combustion of the carbide in the absence of chloride. Thus, the production of the dioxin is completely avoided. The technical prejudice that the production of dioxin is inevitable during the waste incineration is overcome, and the waste incineration does not threaten the health of the ambient residents.

2. No dioxin is produced in the process of destructive distillation and incineration of the waste. Thus, although the fly ash is produced from the incineration of the domestic waste, the fly ash is harmless due to the high temperature treatment. The fly ash can be applied to road paving, manufacture of building material, thus being environment protective.

3. In the destructive distillation and incineration of the waste, neither the waste gas nor CO₂ is discharged from the waste incineration, thus no chimney is required and the harmless treatment of the waste is realized.

4. Because no dioxin is produced from the destructive distillation and incineration of the waste, the waste is directly fed into the incinerator without classification. The storage of the waste is not necessary, neither stench nor leachate is produced, thus, the waste incineration plant can be located in urban area or in waste transfer station to save much cost on the waste transportation.

5. The arrangement of the two layers of grate bars in the combustion section separates the combustion section into the first combustion layer, the second combustion layer, and the third combustion layer to increase a height of the combustion section and to improve the treatment efficiency of the waste. By designing that intervals of an upper layer of the grate bars are wider than intervals of a lower layer of the grate bars, when the carbide on the upper layer of the grate bars is combusted, carbide having reduced volumes automatically drops onto the lower layer of the grate bars to continue combustion. As the volume of the carbide further reduces, the carbide falls to the third combustion layer, or the ash discharging section, to continue combustion until the carbide is completely combusted, thus realizing the automatic fire poking, and greatly improving the combustion of the carbide and the treating efficiency of the waste.

6. The negative-pressure combustion is adopted to substitute the positive-pressure combustion in the conventional waste incinerator. The negative-pressure combustion also makes the waste feeding port and the ash discharge port in a negative-pressure state. Pressures inside and out of the waste incinerator are in balance, no sealing measurement is required. When the waste incinerator communicates with an external, no leakage of the coal gas occurs, and the incinerator ash is discharged outside. As the gasification agent, the air or the oxygen-enriched air and water vapor are sucked into the combustion section by the draft fan, no large pressure is required to penetrate the ash layer, so that no large quantity of fly ash is caused, the ash in the mixed coal gas is greatly reduced. The coal gas chamber has large enough cross section area, the flow rate of the coal gas is low, the ash with large particles falls, functioning in ash falling. In the meanwhile, the pyrogenic coal gas is extracted to the lower part of the coal gas chamber, and is further pyrolyzed into large molecular substances, such as tar and phenol, under the action of the heat quantity of the coal gas in the lower part of the coal gas chamber, so that the pollution of the tar and the phenol is avoided.

7. The process of the invention is able to fully utilize the resource in the waste. The water vapor produced in the waste drying is utilized as the gasification agent as well as the dedusting agent for the mixed coal gas. The heat quantity consumed in the waste drying is recovered, and even CO₂ produced from the combustion is reduced into the coal gas CO for utilization. Therefore, the utilization of the waste resource is improved. Taken the power generation using the mixed coal gas as an example, no additional boiler is required, the mixed coal gas is able to directly drive the coal gas turbine for electric power generation and the efficiency thereof exceeds 35%, which is increased by at least one-fold, compared with the electricity generation of those waste incinerator adopting the waste heat boiler and the steam turbine. When the oxygen-enriched combustion is applied, the combustion efficiency is further improved, the electricity generation is much higher, thus having lower operation cost and gain much higher benefit.

8. The structure and the process of the waste destructive distillation incinerator of the invention adopts the oxygen-enriched air as the combustion-supporting agent to substitute the air. In one aspect, the oxygen-enriched combustion decreases the burning point of the fuel, increases the combustion temperature, makes the carbide completely combusted, and reduces the carbon content in the ash; and in the other respect, the water vapor supply is increased while the air supply is reduced, so that the nitrogen content in the mixed coal gas is lowered, the caloric value and the total heat quantity of the coal gas are improved, all these make the resource fully utilized.

9. The combustion state is in closed-loop control using the system for automatic closed-loop control of the combustion temperature. When the combustion temperature of the waste in a certain zone is not high enough, the air or the oxygen-enriched air is fed via an auxiliary gas/water feeding channel to enhance combustion of the carbide and maintain the combustion temperature to be constant. When the combustion temperature of a certain zone is too high, the water vapor produced from the drying of the waste is fed via the auxiliary gas/water feeding channel to decrease the combustion temperature. The water vapor is reduced by the high temperature carbide in the reduction section to produce H₂ and CO, thus further reducing the combustion temperature, maintaining normal combustion state, and improving a caloric value of the coal gas by production of H₂. The optimum temperature is determined according to the operational experience, and the best control of the combustion is therefore realized.

10. The waste incinerator adopting the vertical structure and the negative-pressure mode has the simple structure and occupies a smaller area. The fire in the incinerator can be sealed, the waste storage is unnecessary, no leachate is produced, no stench treatment is required, thus being environmental friendly. The waste incinerator can be constructed on the landfill site, the daily produced waste as well as the waste stored in the landfill site can be treated, thus gradually recover the original ecological environment of the landfill site.

11. The structure and the incineration process of the waste incinerator of the invention completely avoids the discharge of the methane in the waste landfill. The waste is converted into the clean fuel gas which is able to substitute the fossil fuel for electric power generation. The energy is saved while the discharge is reduced, and the carbon indicator can be traded. No fly ash is produced, the daily waste is daily treated, no stench or leachate is resulted, thus realizing the real minimization of the pollution and the toxicity.

12. The waste is converted into clean fuel gas, which can be applied in multiple occasions, and can be directly applied to the residential fuel gas, or supplied to the industrial boiler, or utilized for electric power generation which has much higher efficiency than that of the electric power generation by the waste incineration. When the clean fuel gas is applied in baking bricks, the inorganic matters in the waste can be used as the raw materials for the bricks, thus realizing complete resource recovery of the waste. Finally, the clean fuel gas can be used for artificial synthesis as well.

13. The structure of the waste incinerator can be realized by unitary mass production and can be produced in batches and modular installation. A large-scale of the structure is realized by unit combinations, so as to satisfy the requirement of the large-scale waste treatment for large cities.

### BRIEF DESCRIPTION OF THE DRAWINGS

The invention is described hereinbelow with reference to the accompanying drawings, in which:

FIG. 1A is a structure diagram of a standard vertical type negative-pressure waste incinerator utilizing destructive distillation in the form of a single furnace;

FIG. 1B is a cross sectional view (taken from line MM of FIG. 1A) of a drying section of a standard vertical type negative-pressure waste incinerator utilizing destructive distillation in the form of a single furnace;

FIG. 1C is a cross section view (taken from line NN of FIG. 1A) of a destructive distillation section of a standard vertical type negative-pressure waste incinerator utilizing destructive distillation in the form of a single furnace;

FIG. 2A is a structure diagram of a standard vertical type negative-pressure waste incinerator utilizing destructive distillation in the form of a double-furnace;

FIG. 2B is a cross section view (taken from line AA of FIG. 2A) of a destructive distillation section of a standard vertical type negative-pressure waste incinerator utilizing destructive distillation in the form of a double-furnace, in which, the incinerator is divided into 6 zones for closed-loop control of the combustion temperature; and

FIG. 3 is a structure diagram of a large-scale negative-pressure destructive distillation incinerator for treating the domestic waste formed by combinations of units of a standard vertical type negative-pressure destructive distillation incinerator for treating the domestic waste adopting a double-furnace.

In the drawings, the following numbers are adopted: 1. Front air (oxygen-enriched air) inlet chamber; 2. Front incinerator door; 3. Lower layer of grate bars; 4. Gas (air/oxygen-enriched air)/water (vapor) feeding channel; 5. Upper layer of grate bars; 6. Multiple temperature detecting points for closed-loop control of a combustion temperature; 7. Lower coal gas chamber disposed in a destructive distillation section; 7-I. First zone of the lower coal gas chamber; 7-II. Second zone of the lower coal gas chamber; 7-III. Third zone of the lower coal gas chamber; 7-IV. Fourth zone of the lower coal gas chamber; 7-V. Fifth zone of the lower coal gas chamber; and 7-VI. Sixth zone of the lower coal gas chamber; 8. Thermal insulation layer surrounding the incinerator; 9. Upper coal gas chamber disposed in a drying section; 10. Cooling plate in the drying section for improving heat transfer and water vapor discharge; 11. Gas collection pipe for gathering a mixed coal gas; 12. Waste pushing cylinder; 13. Waste feeding port; 14. Waste feeding throttle; 15. Waste pressing plate; 16. Waste pressing cylinder; 17. Void layer; 18. Upper section gas (water vapor) outlet; 19. Mixed coal gas outlet; 20. Pneumatic draft fan or Roots blower; 21. Incinerator housing; 22. Drying section; 23. Destructive distillation section; 24. Reduction section; 25, 26, 27. Combustion section, in which, 25. First combustion layer, 26. Second combustion layer, and 27. Third combustion layer, or ash section; 28. Rear incinerator door; 29. Rear air (oxygen-enriched air) inlet chamber; 30. Ash chute; 31. Middle lower coal gas chamber; 32. Middle cooling plate; 33. Waste distribution plate; 34. Middle upper coal gas chamber; 35. Manhole; 36. Upper section gas collection pipe; 37. Pneumatic draft fan or Roots blower; I. First standard unit of the waste destructive distillation incinerator; II. Second standard unit of the waste destructive distillation incinerator; III. Third standard unit of a waste destructive distillation incinerator; IV. Fourth standard unit of the waste destructive distillation incinerator; and N. N-th standard unit of the waste destructive distillation incinerator.

### DETAILED DESCRIPTION OF THE EMBODIMENTS

For further illustrating the invention, experiments detailing a waste incinerator are described below. It should be noted that the following examples are intended to describe and not to limit the invention.

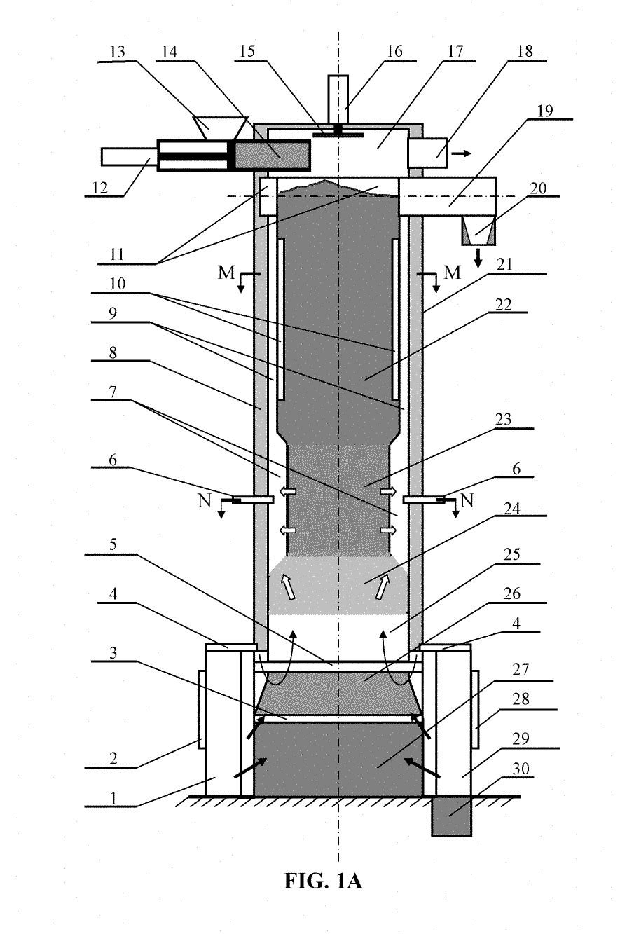

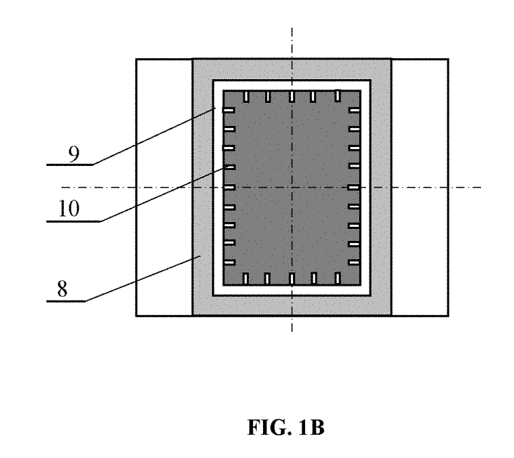

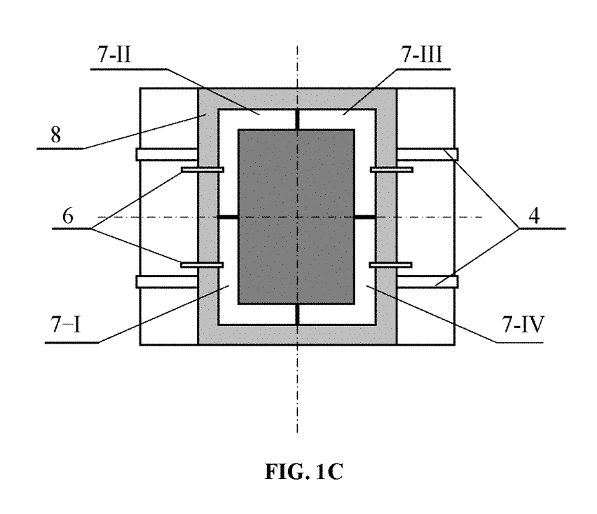

As shown in FIG. 1A, a vertical type negative-pressure incinerator utilizing destructive distillation adopts a cubic and open structure. Inside the unit of the destructive distillation incinerator, a drying section 22, a destructive distillation section 23 are filled with the waste. The non-combusted high-temperature carbide after destructive distillation is accommodated in the reduction section 24. The combustion section is divided, by an upper layer of grate bars 3 and a lower layer of grate bars 5, into a first combustion layer 25, a second combustion layer 26, and a third combustion layer 27 (also an ash section), and the carbide being combusted is accommodated in the combustion section. The waste reaching the destructive distillation section 23 is totally dried and does not contain any water content, only in such condition, the waste can be decomposed into the carbide residue. The carbide residue then drops down to the reduction section 24 where the carbide residue is heated to a high temperature state. Thereafter, the carbide residue reaches the first combustion layer 25 and is fully combusted when contacting with the air or the oxygen-enriched air. The waste incinerator in the prior art adopts direct combustion of the waste without destructive distillation, which has poor combustibility. Incomplete drying of the waste always causes the difficulty in combustion and defects of incomplete combustion of the waste. As intervals of an upper layer of the grate bars are wider than intervals of a lower layer of the grate bars, when the carbide in the first combustion layer 25 is combusted, carbide having reduced volumes automatically drops to the second combustion layer 26 to continue combustion; as the volume of the carbide further reduces, the carbide falls from the lower layer of the grate bars 3 to the third combustion layer 27 to continue combustion until the carbide is completely combusted. Incombustible ash remains in the ash section 27 and is input by an ash discharging mechanism to an ash chute 30 so as to discharge the ash out of the incinerator. In condition that the ash has large mass and is unable to drop to the ash section, the door of the incinerator is open to picked out the ash of the large mass by a hook. The upper layer of grate bars 5 and the lower layer of grate bars 3 adopts different intervals to realize the automatic fire poking, enlarge the height of the combustion zone, improve the combustion efficiency, and ensure complete combustion of the carbide. Side walls of furnaces 7, 9, cooling plates 10, and gas collection pipes 11 are made of stainless refractory steel to ensure the high-temperature endurance of such structures. Besides, by automatic closed-loop control of the combustion temperature, abnormal combustion is avoided. An outer layer 8 of the coal gas chamber is a thermal insulation layer and filled with materials possessing excellent thermal insulation (the coefficient of heat conduction is generally lower by one magnitude order than the common refractory material), and an outer surface of the incinerator is provided with a protective shell 21.

To realize the automatic closed-loop control of the combustion temperature (as shown in FIG. 1C), the lower part of the coal gas chamber 7 is divided into four zones 7-I, 7-II, 7-III, and 7-IV. Temperatures of the coal gas chamber detected by the temperature monitoring points 6 represent the combustion state of corresponding zones.

Corresponding gas/water feeding channels 4 are controlled by the system for automatic closed-loop control of the combustion temperature, the air (oxygen-enriched air) or the water vapor is fed to the incinerator to ensure normal and stable combustion temperature of the incinerator. Such structure design is very compact, more simplified, more reasonable, and superior than the incinerators in the prior art (for example, the automatic fire poking and the automatic closed-loop control of the combustion, the enlargement of the combustion zone, and the improvement of the efficiency).

The incineration process of the vertical type negative-pressure incinerator utilizing destructive distillation is as follows: the waste is fed in from the waste feeding port 13 of an automatic loading system, and pushed by a waste pushing cylinder 12 to a feeding throttle. The prior waste in the waste feeding throttle is pushed into the incinerator. Because the negative-pressure combustion mode is adopted, a void layer 17 inside the incinerator is in a slight negative-pressure state. The feeding throttle is filled with the waste thus functions in separating the internal incinerator from the external. The plastics in the waste after being heated is possibly hardened, which prevents the waste from falling and results in waste blockage. A top of the incinerator is provided with the waste pushing cylinder 16 to press a waste pressing plate 15, so that the fluent descending of the waste, the normal drying, destructive distillation, and combustion of the carbide are ensured. The water vapor produced from the waste drying process ascends to the void layer 17 to form an upper section gas via the gaps among the waste between the adjacent cooling plates 10. The water vapor is predominant in the upper section gas. The water vapor is used as the gasification agent for gasification of the carbide via an outlet 18 of the upper section gas and used as auxiliary complemented water vapor by the system for automatic control of the combustion temperature. The coal gas and the pyrogenic coal gas are mixed in the coal gas chambers 7, 9 to form a mixed coal gas, which is then accumulated by a mixed coal gas collection pipe 11 and output from a mixed coal gas outlet at the top of the incinerator for electric power generation or other application. The remaining water vapor and the mixed coal gas is merged, and wrapped the soot and the ash in the mixed coal gas to form a haze. The haze is thrown to water by a Venturi scrubber and therefore removed.

As the destructive distillation of the waste is performed before the combustion of the carbide, neither the production of dioxin nor the discharge of the waste gas is resulted. Thus, it is not necessary to heating the waste gas to a temperature of exceeding 850° C. and the problem that a large quantity of waste gas (at the temperature of between 200 and 300° C.) carries away a large quantity of heat energy does not exist. The direct use of the fuel gas turbine combined with a waste heat steam turbine IGCC for electric power generation, the power generation efficiency can reach between 35% and 45%, compared with the use of the waste heat boiler and steam turbine as the only choices for electric power generation for the waste incineration, the efficiency exceeds approximately 20%, thus being heat energy-saving and efficient in power generation, and the electric energy production is increased by at least one fold. However, the combustion of the carbide leads to existence of nitrogen residue of the air in the mixed coal gas, thus the caloric value is not high. In order to improve the caloric value of the mixed coal gas, and the oxygen-enriched air is utilized as a combustion agent if the conditions are possible. When the oxygen content in the air is increased from 21% to 30%, the following effects are realized: first, the temperature of the fire point of the fuel is reduced, the combustion speed of the fuel is accelerated, and the complete combustion of the fuel is realized; second, the flame temperature is increased, the combustion degree of the flame is improved, and the released heat quantity is increased; third, as the reduction of the air correspondingly makes the nitrogen gas content reduce, the caloric value of the fuel gas is improved; fourth, the increase of the combustion temperature inevitably increase the water vapor to maintain a stable combustion temperature, and further improve the caloric value of the mixed fuel gas (reduce the nitrogen gas but increase the nitrogen gas); and fifth, the complete combustion of the carbide and the increase of the hydrogen gas are able to increase a total caloric value of the mixed coal gas and therefore generate more electric power.

The destructive distillation incinerator of the invention adopts the vertical structure. A large quantity of waste is accommodated inside the incinerator. As long as the draft fan is not started, the combustion of the carbide is very slow, which is the state of incinerator sealing and the state lasts more than 3 days. This allows the daily treating capacity of the destructive distillation incinerator to be greater than the daily waste production, thus, it is not necessary to store the waste or seal the incinerator. The daily produced waste is daily treated, the waste storage pits, the stench treatment, and the leachate treatment are saved. When the waste incinerator is constructed on the landfill site, the daily produced waste as well as the waste stored in the landfill site can be treated, thus gradually recover the original ecological environment of the landfill site.

In addition, the waste incinerator of the invention does not adopt the common waste feeding method by using grab, because the lifting of the grab lasts a long time, the waste falls from the grab, and the waste feeding port requires a large area, all these are not suitable for the unit combinations of the invention. In the waste incinerator of the invention, the grab is substituted by a hopper car, and a level of the waste detector to detect the level of the waste inside the incinerator in real time. When the level of the waste is lower than the preset value, the automatic loading system is started, the waste is automatically lifted by the hopper car and fed to the incinerator.

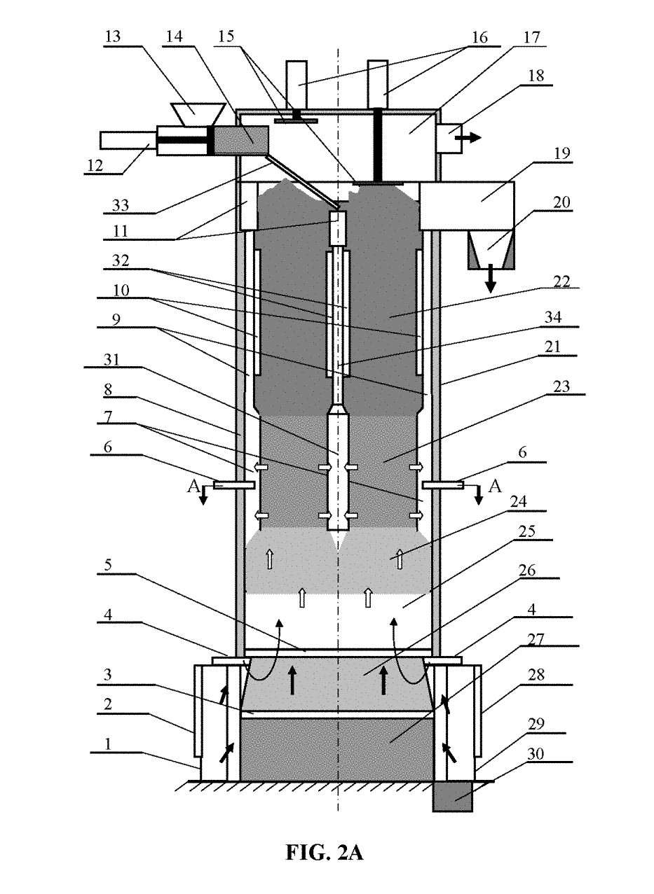

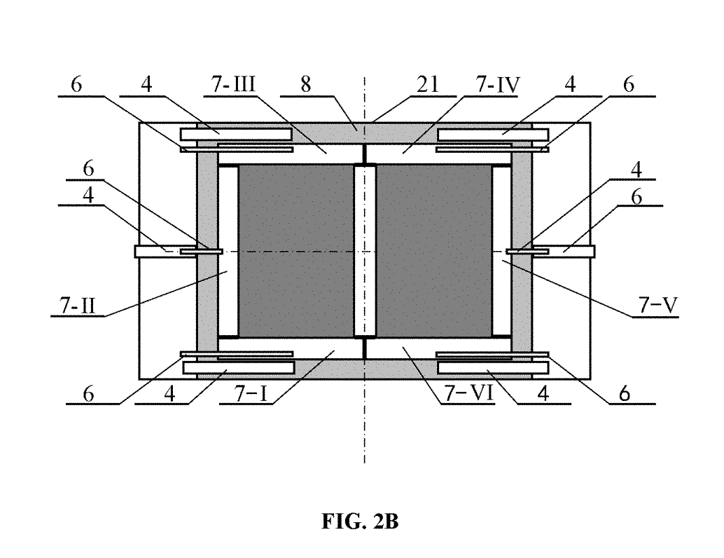

FIG. 2A illustrates a standard unit of a waste incinerator adopting a double-furnace, the basic structure and the incineration process of which are the same as the waste incinerator of FIG. 1A except that an additional furnace is added, and the waste feeding structure at the top of the incinerator is also modified, which is specifically as follows: a waste distributing plate 33 is provided to direct the waste fed to the waste feeding throttle to the front or the rear furnace. The position of the waste distributing plate 33 is as shown in FIG. 2A, which makes the waste distributed in the rear furnace, and when the waste distributing plate 33 is erected, the waste is distributed in the front furnace. Compared with the two waste feeding systems, the waste incinerator as shown in FIG. 2A adopts one feeding system, which is economic and correspondingly saving the area of the waste landfill site.

Because two furnaces are adopted, the coal gas chambers 31, 32 for separating the two furnaces are also provided. In order to realize the automatic closed-loop control of the combustion temperature, as shown in FIG. 2B, the lower part of the coal gas chamber 7 is divided into six zones 7-I, 7-II, 7-III, 7-IV, 7-V, and 7-VI. Six temperature measuring points and six gas/water feeding channels are correspondingly provided as well.

The utilization of the double-furnace makes the treating capacity increase by at least one fold. If the daily treating capacity is smaller than 50 tons, the single-furnace waste incinerator is adopted. The unit of the standard single-furnace waste incinerator has a daily waste treating capacity of 50 tons, and the unit of the standard double-furnace waste incinerator has the daily waste treating capacity of 100 tons. The standard double-furnace waste incinerators are combined to form a large-scale incinerator.

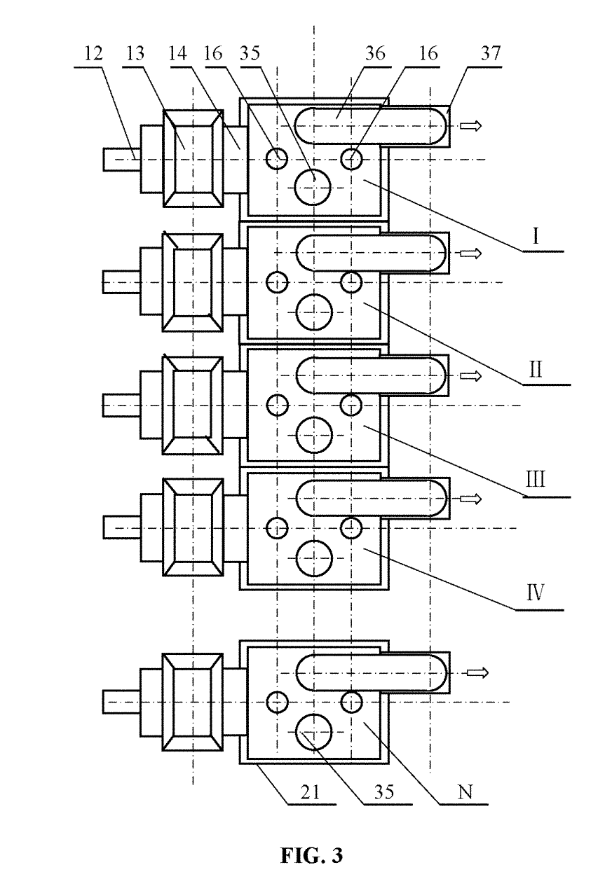

FIG. 3 is a structure diagram of a planar arrangement of a combination of N units of the standard waste incinerators. Considering that each standard waste incinerator has a daily waste treating capacity of 100 tons, the combination of N units of the standard waste incinerators has the daily waste treating capacity of N×100 tons. The combination of 5 units of the standard waste incinerators has the daily waste treating capacity of 500 tons. The combination of 10 units of the standard waste incinerators has the daily waste treating capacity of 1000 tons.

When a smaller incinerator is required, the dimension of the incinerator is properly reduced, to realize different scale of the incinerator possessing the daily waste treating capacity of between 10 and 1000 tons. Because the larger the scale of the incinerator is, the cost for transporting the waste doubles. In the past, considering the production of dioxin, the selection of the site of the waste incinerator is difficult, and the scale of the waste incineration site has to be larger and larger. On the contrary, the waste incinerator of the invention does not exist with the problem of the dioxin production, the scale of the waste treatment plant can be small and a preferable daily waste treating capacity thereof is 500 tons.

### INDUSTRIAL PRACTICABILITY

The vertical type negative-pressure incinerator utilizing destructive distillation of the invention is not only suitable to treat the waste, but also suitable to treat the landfill waste to recover the ecology of the landfill site. The waste incinerator is also applicable to treat and develop the waste of the Pacific plate by constructing a special ship installing with corresponding incinerator, performing destructive distillation, incineration, and gasification; cooling, compressing, refining, and liquefying the fuel gas; and transporting the liquefied fuel gas back to the continent for utilization, thus realizing the pollution treatment of the Pacific plate. Obviously, since the vertical type negative-pressure incinerator utilizing destructive distillation of the invention is able to convert the waste into the clean fuel gas, the straws, falling leaves in the city, and the waste in the forest can be utilized. The production of the clean fuel gas using the destructive distillation and gasification of the invention is of significance in the new energy application.

The occurrence of the two world wars is related to energy competence, and several wars for disputing oil ownership also occurred after the World War II. The new energy has received great attention, especially in Europe, the non-grain biomass energy has been vigorously developed. From a strategic point of view, the new energy that is supposed to substitute the fossil fuel should possess the following conditions:

1. abundant resources, or otherwise the energy needs cannot be met;

2. the production process is simple, the production cost is low, thus being competitive;

3. the large-scale production can be met for the energy needs; and

4. renewable, sustainable, pollution-free, and zero increase of the greenhouse gas. Thus, the real new energy that is substitutable for the fossil fuel is only the non-grain biomass energy.

In Europe, both Germany and Sweden use non-grain biomass to produce biogas, but the investment is large, the scale is small, and the efficiency is low, besides, additional waste ash and liquid are required to be treated. Particularly, 25-50% CO₂ exist in the biogas, resulting in energy waste. Herein the destructive distillation technology is utilized to convert the waste into the clean fuel gas, particularly the critical techniques breaking through the large-scale destructive distillation incinerator, thus totally meet the above conditions. As long as the supplementary construction of the energy forest base and the planting of the fast-growing forest are realized, the waste incinerator of the invention is expected to become the mainstream in the biomass energy technology.

Unless otherwise indicated, the numerical ranges involved in the invention include the end values. While particular embodiments of the invention have been shown and described, it will be obvious to those skilled in the art that changes and modifications may be made without departing from the invention in its broader aspects, and therefore, the aim in the appended claims is to cover all such changes and modifications as fall within the true spirit and scope of the invention.

The invention claimed is:

1. A waste incinerator, being in a vertical structure and comprising from the top down:
a drying section;
a destructive distillation section;
a reduction section; and
a combustion section comprising: two layers of grate bars, a first combustion layer, a second combustion layer, and a third combustion layer;
wherein
in operation,
waste introduced into the waste incinerator is first dried in the drying section where water vapor is produced and used as a gasification agent and a dedusting agent of fuel gas and also used to exclude air from gaps among the waste;
the waste is then introduced downward to the destructive distillation section where organic matters are heated for destructive distillation and decomposition to yield a pyrogenic coal gas and a carbide;
the pyrogenic coal gas enters a coal gas chamber and is collected; a part of the pyrogenic coal gas passes through the gaps among the waste to exclude the water vapor and make the waste decomposed in the absence of the air;
the carbide is further introduced downward to the first combustion layer and contacts with the gasification agent for combustion; the non-combusted carbide is heated by heat quantity produced from the combustion to form the reduction section;
CO₂ produced from the combustion is reduced to CO as a coal gas when rising to the reduction section, and at the same time contacts with H₂O to produce H₂ and CO, and the reduced products enter the coal gas chamber and are mixed with the pyrogenic coal gas to form a mixed coal gas which ascends and provides heat quantity to destructive distillation and waste drying;
a negative-pressure combustion mode is adopted, when the mixed coal gas is being extracted by a draft fan, a gasification agent comprising a mixture of the air or an oxygen-enriched air and the water vapor is sucked into the combustion section to make the carbide totally combusted;
the waste incinerator is divided into between 4 and 8 zones in a horizontal cross section, and a combustion temperature is controlled to be constant by using a system for automatic closed-loop control of the combustion temperature; and
a standard unit of the waste incinerator adopts a cubic incinerator, and the waste incinerator is formed by any combinations of standard units according to requirement.

2. The waste incinerator of claim 1, wherein no dioxin is produced; the air leaving in the gaps among the waste is excluded out of the drying section by the water vapor; and the water vapor is excluded out of the destructive distillation section by the destructed distillated coal gas to satisfy seclusion from the air as required by the destructive distillation of the waste; the waste is heated by the combustion of the carbide as well as radioactively heated by the coal gas via a lower part of the coal gas chamber to carry out destructive distillation and decomposition; the organic matters are decomposed into alkanes of small molecules and carbide residues; no dioxin is produced as no oxidation occurs; the carbide residues drop to a lower part of the incinerator for combustion where no dioxin is produced in the absence of chloride so that a process of waste incineration including destructive distillation followed by combustion of the carbide is realized and the production of the dioxin is avoided.

3. The waste incinerator of claim 1, wherein exhaust of the waste gas is deleted to make waste incineration harmless; the heat quantity produced from the combustion of the carbide of the first combustion layer is directly used to heat the non-combusted carbide in the reduction section; the heated carbide functions as the reducing agent; CO₂ produced from the combustion of the carbide is sucked by a draft fan and passes through the reduction section where CO₂ is reduced into CO as the coal gas; heat quantities from the reduction section and the irradiative heating by the coal gas in the lower part of the coal gas chamber are provided to the destructive distillation of the waste; slits are disposed on an inner wall of the lower part of the coal gas chamber to allow the pyrogenic coal gas to enter the lower part of the coal gas chamber via the slits and merge with the coal gas; the mixed coal gas ascends and supplies heat quantity radioactively for drying the waste via an upper part of the coal gas chamber and cooling fins; water vapor produced from the drying of the waste passes through gaps among the waste at corners of the cooling fins and reaches a top of the waste incinerator for collection, so that the exhaust of the waste gas is deleted and the harmless waste incineration is realized.

4. The waste incinerator of claim 1, wherein the two layers of grate bars are utilized to improve the treatment efficiency and realize automatic fire poking; the arrangement of the two layers of grate bars in the combustion section separates the combustion section into the first combustion layer, the second combustion layer, and the third combustion layer, which also functions as an ash discharge section, to increase a height of the combustion section and improve the treatment efficiency of the waste; by designing that intervals of an upper layer of the grate bars are wider than intervals of a lower layer of the grate bars, when the carbide on the upper layer of the grate bars is combusted, carbide having reduced volumes automatically drops onto the lower layer of the grate bars to continue combustion; as the volume of the carbide further reduces, the carbide fall to the third combustion layer, or the ash discharging section, to continue combustion until the carbide is completely combusted, thus realizing the automatic fire poking.

5. The waste incinerator of claim 1, wherein the negative-pressure combustion is adopted to realize sealing of a waste feeding port and an ash discharge port, remove ash from the fuel gas, and decrease the pollution; the negative-pressure combustion also makes both the waste feeding port and the ash discharge port in a negative-pressure state; pressures in and out of the waste incinerator are in balance, no sealing measurement is required; when the waste incinerator communicates with an external, no leakage of the coal gas occurs, and the incinerator ash is discharged outside; as the gasification agent, the air or the oxygen-enriched air and water vapor are sucked into the combustion section by the draft fan, no large pressure is required to penetrate the ash layer, so that no large quantity of fly ash is resulted, the ash in the mixed coal gas is greatly reduced; and besides, the coal gas chamber has large enough cross section area, the flow rate of the coal gas is low, and the ash with large particles falls down, functioning in ash falling.

6. The waste incinerator of claim 1, wherein the waste incinerator is divided into between 4 and 8 zones in the horizontal cross section, and the combustion state is in a closed-loop control using the system for automatic closed-loop control of the combustion temperature; when the combustion temperature of the waste in a certain zone is not high enough, the air or the oxygen-enriched air is fed via an auxiliary gas/water feeding channel to enhance combustion of the carbide and maintain the combustion temperature to be constant; when the combustion temperature of a certain zone is too high, the water vapor produced from the drying of the waste is fed via the auxiliary gas/water feeding channel to decrease the combustion temperature; and the water vapor is reduced by the high temperature carbide in the reduction section to produce H₂ and CO, thus further reducing the combustion temperature, maintaining normal combustion state, and improving a caloric value of the coal gas by production of H₂.

7. The waste incinerator of claim 1, wherein the oxygen-enriched air is adopted as a combustion-supporting agent; considering the full utilization of the resource, the carbide is required to be fully combusted; the oxygen-enriched air combustion is an effective method, on the one side, the oxygen-enriched air decreases a burning point of the fuel, improving the combustion temperature, the carbide is fully combusted, and a carbon content of the ash is reduced; on the other side, the supply of the water vapor is increased, the supply of the air is reduced, and the caloric value and a total heat quantity of the coal gas are improved.

8. The waste incinerator of claim 1, wherein the energy saving is significant, and the electricity generation is increased by at least one fold; because no dioxin is produced and no waste gas is discharged, the waste gas is not required to heated to exceeding 850° C.; no large amount of heat quantity is carried away by the waste gas; a coal gas turbine and a steam turbine are directly adopted to form an IGCC system for electric power generation, and a power generation efficiency reaches between 35% and 45%; compared with the electric power generation by using the waste incineration, the waste heat boiler, and the steam turbine that has the efficiency of equal to or less than 20%, the electric energy production of the IGCC system is increased by at least one fold.

9. The waste incinerator of claim 3, wherein the energy saving is significant, and the electricity generation is increased by at least one fold; because no dioxin is produced and no waste gas is discharged, the waste gas is not required to heated to exceeding 850° C.; no large amount of heat quantity is carried away by the waste gas; a coal gas turbine and a steam turbine are directly adopted to form an IGCC system for electric power generation, and a power generation efficiency reaches between 35% and 45%; compared with the electric power generation by using the waste incineration, the waste heat boiler, and the steam turbine that has the efficiency of equal to or less than 20%, the electric energy production of the IGCC system is increased by at least one fold.

10. The waste incinerator of claim 7, wherein the energy saving is significant, and the electricity generation is increased by at least one fold; because no dioxin is produced and no waste gas is discharged, the waste gas is not required to heated to exceeding 850° C.; no large amount of heat quantity is carried away by the waste gas; a coal gas turbine and a steam turbine are directly adopted to form an IGCC system for electric power generation, and a power generation efficiency reaches between 35% and 45%; compared with the electric power generation by using the waste incineration, the waste heat boiler, and the steam turbine that has the efficiency of equal to or less than 20%, the electric energy production of the IGCC system is increased by at least one fold.

11. The waste incinerator of claim 1, wherein the resource is fully utilized, the water vapor produced in the drying of the waste is used as the gasification agent for the combustion of the carbide, the heat quantity consumed in the drying of the waste is recovered and a special drum is not required; the investment is saved, the utilization efficiency of the heat energy is improved, and the structure of the incinerator is simplified; when a large-scale waste destructive distillation incinerator is utilized, the remaining water vapor and the mixed coal gas are merged and wrap the ash to form a haze and the ash is removed by a Venturi scrubber, thus the water vapor and the mixed coal gas function as a dedusting agent; and CO₂ produced from the combustion of the carbide is reduced to CO for collection and utilization, so that the resource is fully utilized.

12. The waste incinerator of claim 3, wherein the resource is fully utilized, the water vapor produced in the drying of the waste is used as the gasification agent for the combustion of the carbide, the heat quantity consumed in the drying of the waste is recovered and a special drum is not required; the investment is saved, the utilization efficiency of the heat energy is improved, and the structure of the incinerator is simplified; when a large-scale waste destructive distillation incinerator is utilized, the remaining water vapor and the mixed coal gas are merged and wrap the ash to form a haze and the ash is removed by a Venturi scrubber, thus the water vapor and the mixed coal gas function as a dedusting agent; and CO₂ produced from the combustion of the carbide is reduced to CO for collection and utilization, so that the resource is fully utilized.

13. The waste incinerator of claim 7, wherein the resource is fully utilized, the water vapor produced in the drying of the waste is used as the gasification agent for the combustion of the carbide, the heat quantity consumed in the drying of the waste is recovered and a special drum is not required; the investment is saved, the utilization efficiency of the heat energy is improved, and the structure of the incinerator is simplified; when a large-scale waste destructive distillation incinerator is utilized, the remaining water vapor and the mixed coal gas are merged and wrap the ash to form a haze and the ash is removed by a Venturi scrubber, thus the water vapor and the mixed coal gas function as a dedusting agent; and CO₂ produced from the combustion of the carbide is reduced to CO for collection and utilization, so that the resource is fully utilized.

14. The waste incinerator of claim 1, an automatic loading system comprising a hopper car is adopted to substitute a conventional grab; a level of the waste detector is utilized to detect a level of the waste inside the incinerator in real time; and when the level of the waste inside the incinerator is lower than a preset value, the hopper car automatically operates to load the waste.

15. The waste incinerator of claim 3, an automatic loading system comprising a hopper car is adopted to substitute a conventional grab; a level of the waste detector is utilized to detect a level of the waste inside the incinerator in real time; and when the level of the waste inside the incinerator is lower than a preset value, the hopper car automatically operates to load the waste.

16. The waste incinerator of claim 1, wherein the daily produced waste is daily treated, no pollution is resulted, thus realizing the real minimization; the minimization is the purpose of the waste treatment that converting the waste into useful clean fuel gas without producing the pollution and toxic matters including incombustible fly ash, leachate, and stench, and realizing energy conservation.

17. The waste incinerator of claim 3, wherein the daily produced waste is daily treated, no pollution is resulted, thus realizing the real minimization; the minimization is the purpose of the waste treatment that converting the waste into useful clean fuel gas without producing the pollution and toxic matters including incombustible fly ash, leachate, and stench, and realizing energy conservation.

18. The waste incinerator of claim 1, wherein a combination of units of the waste incinerator is adopted to realize a large-scale of the waste incinerator; because the waste is not air permeable and is heated only by radiation, the incinerator cannot be amplified unlimitedly; considering the large-scale problem of the waste incinerator, a unit incinerator is not required to have great waste treating capacity, because the great waste treating capacity requires enlarged dimension of the incinerator, which results in uneven of the heating, accordingly direct combustion of the waste, and the production of dioxin; thus, the furnace of the incinerator adopts a rectangular cross section to form a rectangular furnace body of a standard unit of a waste destructive distillation incinerator; the negative-pressure combustion is adopted, which is beneficial to the unit combination; the standard production is adopted; each standard unit is designed according to a daily treating capacity of between 50 and 100 tons; when a larger treating capacity is necessitated, a combination of the units is adopted; when it is required to reduce the treating capacity, the dimension of the unit is reduced, so that the daily treating capacity of between 10 and 1000 tons is realized.

19. The waste incinerator of claim 5, wherein a combination of units of the waste incinerator is adopted to realize a large-scale of the waste incinerator; because the waste is not air permeable and is heated only by radiation, the incinerator cannot be amplified unlimitedly; considering the large-scale problem of the waste incinerator, a unit incinerator is not required to have great waste treating capacity, because the great waste treating capacity requires enlarged dimension of the incinerator, which results in uneven of the heating, accordingly direct combustion of the waste, and the production of dioxin; thus, the furnace of the incinerator adopts a rectangular cross section to form a rectangular furnace body of a standard unit of a waste destructive distillation incinerator; the negative-pressure combustion is adopted, which is beneficial to the unit combination; the standard production is adopted; each standard unit is designed according to a daily treating capacity of between 50 and 100 tons; when a larger treating capacity is necessitated, a combination of the units is adopted; when it is required to reduce the treating capacity, the dimension of the unit is reduced, so that the daily treating capacity of between 10 and 1000 tons is realized.
